(19) United States
(12) Patent Application Publication
(10) Pub. No.: US 2009/0054109 A1
(43) Pub. Date: Feb. 26, 2009

(54) POLYPHONIC RINGTONE ANNUNCIATOR WITH SPECTRUM MODIFICATION

(75) Inventor: Nevil Hunt, Berkshire (GB)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/912,363

(22) PCT Filed: Nov. 22, 2006
(86) PCT No.: PCT/JP2006/323870

§ 371 Date: Oct. 23, 2007

(30) Foreign Application Priority Data
Nov. 23, 2005 (GB) 0523819.1

(51) Int. Cl. H04B 1/38

(52) U.S. Cl. 455/567

(57) ABSTRACT

In a portable wireless transceiver such as a mobile telephone, the spectral content of a polyphonic ringtone is reduced if a call is not answered after a predetermined period of time, in order to render the ringtone more audible.

### TECHNICAL FIELD

The present invention relates to call annunciators suitable for portable wireless transceivers such as mobile telephones.

### BACKGROUND ART

Such telephones use ringtones to let the user know that a call has been received. Popular ringtones are usually polyphonic ringtones which drive a loud speaker to produce a large range of frequencies (wide spectrum). There are restrictions in the size and cost of loud speakers used for mobile telephones. This means that only a certain amount of power can be put into the ringtones. When the available power is spread across a large number of frequencies (as in polyphonic tones) it can be difficult for the user to hear the ringtone. Polyphonic ringtones can be difficult for the human ear to pick out from background noise (e.g. in a noisy supermarket).

### DISCLOSURE OF INVENTION

The present invention provides a call annunciator for a portable wireless transceiver having a polyphonic ringtone generator, a speaker for reproducing the polyphonic ringtone and means for modifying the spectral content and amplitude of signals applied to the speaker, the modifying means being arranged to reduce the spectral content of the ringtone after a predetermined period whilst maintaining overall power.

The reduction of the spectral content of the ringtone makes it easier for the ear to pick out of background noise at the same time allowing the ringtone volume to be increased without damage to the speaker.

### BRIEF DESCRIPTION OF DRAWINGS

FIG. 1 is schematic diagram illustrating the components of a call annunciator for a portable wireless transceiver according to one embodiment of the present invention.

FIGS. 2a and 2b are graphs of gain versus frequency for a polyphonic ringtone before and after modification in the first embodiment of the invention.

FIGS. 3a, b and c are graphs indicating degree of ‘spectral ramping’ versus time according to three possible operating schemes.

FIG. 4 is a graph of gain versus frequency showing a second example of ringtone modification.

FIGS. 5a and 5b are graphs of gain versus frequency before and after amplification of dominant frequencies plus harmonics.

### BEST MODE FOR CARRYING OUR THE INVENTION

The human ear has maximum response at about 3.5 kHz-4 kHz with good response between about 1 and 5 kHz. It also has good response at about 13 kHz. Atypical mobile phone speaker has optimum efficiency at about 7 kHz with good efficiency from about 2 to 12 kHz.

The simplest implementation of this “Spectral Ramping” idea would be to attenuate ringtone frequencies below about 2 kHz whilst amplifying frequencies above 2 kHz, particularly amplifying at 3 kHz-8 kHz where both human hearing and the speaker efficiency are at a maximum. It may also be beneficial to amplify at about 13 kHz where the human ear also has good response.

Further enhancements and alternatives to the above implementation could be developed by utilising the science of “psychoacoustics” which is the study of how the human ear works in conjunction with the human brain to respond and react to sounds. These include:

Introduce “Spectral Ramping” gradually if call is not answered after a predetermined time (say 10 seconds)

Introduce “Spectral Ramping” suddenly if call is not answered after a predetermined time (say 10 seconds) since the human hearing is good at detecting sudden changes in sounds and this may make it more noticeable

Switch “Spectral Ramping” in and out in bursts if call is not answered after a predetermined time (say 10 seconds) if this makes it more noticeable

Ramping by using multiple bandpass filters if this creates sound that is more noticeable (e.g. 4 kHz and 13 kHz—the frequencies at which the human ear has maximum response)

Ramping by deliberately distorting the ringtone by clipping at the maximum speaker voltage if this creates a sound that is more noticeable

Ramping by using an intelligent filter to amplify only the dominant frequencies plus harmonics within the ringtone while suppressing other frequencies if this creates a sound that is more noticeable

Ramping by using an intelligent gain control to make quiet parts of the ringtone even quieter thus making the louder parts stand out by enhancing their “attack”

An evaluation of the effectiveness of the above ideas would have to be carried out with a range of people in a range of ambient noise environment and with a range of ringtones to establish their effectiveness

An embodiment of the invention will now be described by way of example only and with reference to the accompanying drawings.

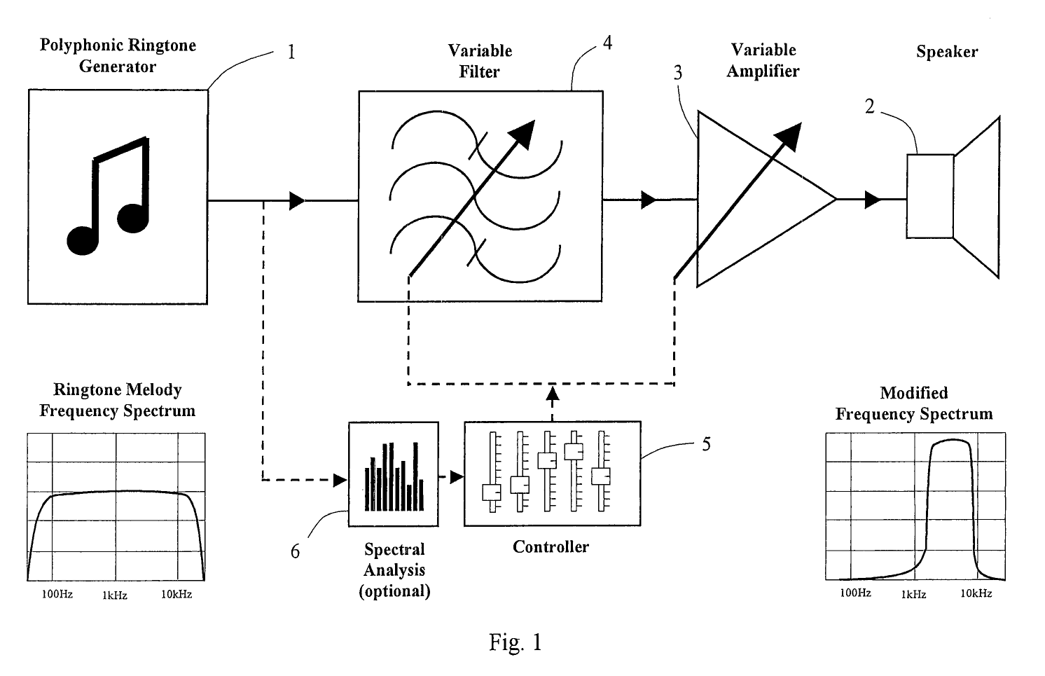

Referring firstly to FIG. 1, a call annunciator for a mobile transceiver typically includes a ringtone generator 1 connected to a speaker 2. The construction of these components is well known in the art and will not be described in further detail. Some call annunciators have the facility to gradually increase the volume in which case a variable amplifier 3 supplies signals to the speaker 2.

In the embodiment of the invention as illustrated in FIG. 1, the output of the ringtone generator 1 is supplied to a variable filter 4 before being applied to the variable amplifier 3 and speaker 2. A controller 5 controls the variable filter 4 and the variable amplifier 3. In some embodiments of the invention, the controller operates in response to an input signal from a spectral analyser 6.

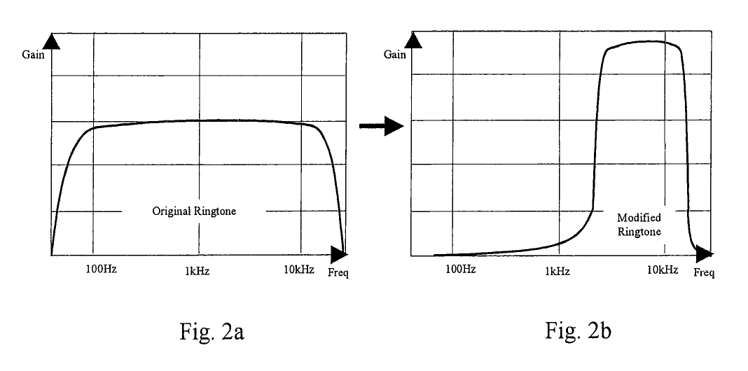

A first example of ringtone modification is illustrated in FIGS. 2a and 2b. FIG. 2a shows the original ringtone having a broad frequency spectrum. The full spectrum passes through the filter and the amplifier gain is generally constant over the whole spectrum from 100 Hz to 10 kHz. If this original ringtone is not answered, it is modified as shown in FIG. 2b. Here, the passband of the variable filter has been narrowed to include only the upper part of the frequency spectrum but the gain has been increased so that the overall power is maintained. This is achieved through the controller 5 varying the passband of the filter and the amplification of the amplifier 3 so as to maintain overall power.

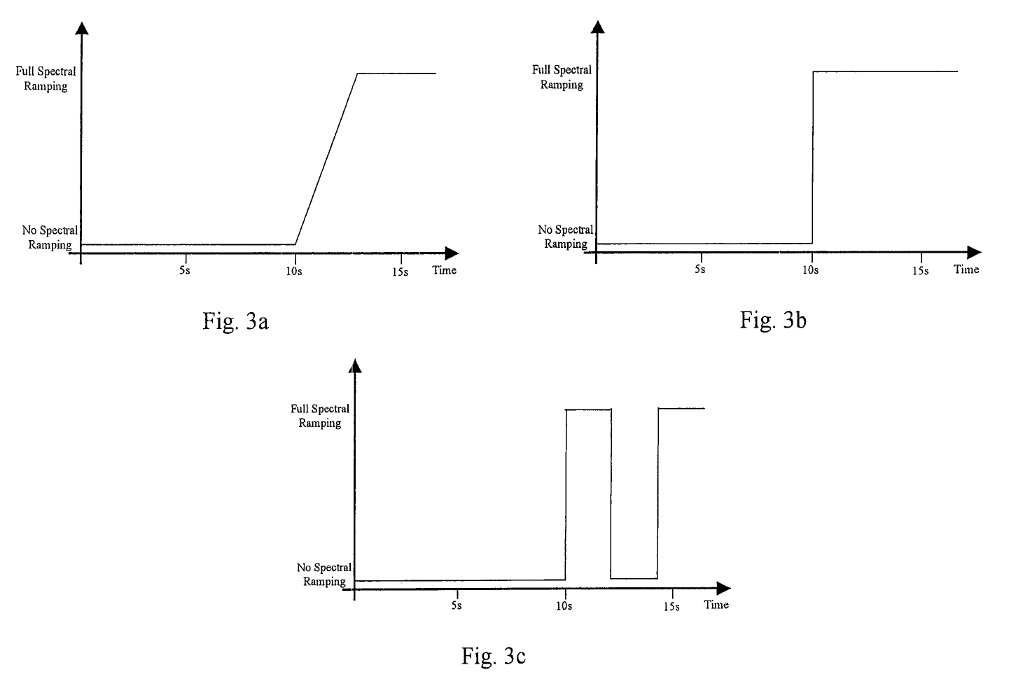

Referring now to FIG. 3a, the narrowing of the passband and corresponding increase in power, referred to as “spectral ramping” in FIG. 3a, may be introduced gradually after a period of 10 seconds over a period of for example 2 seconds. Alternatively, as shown in FIG. 3b, the change from wide to narrow passband and corresponding increase in gain can be achieved in one step. As shown in FIG. 3c, the switch between the profiles shown in FIGS. 2a and 2b can be repeated at intervals, for example 2 seconds.

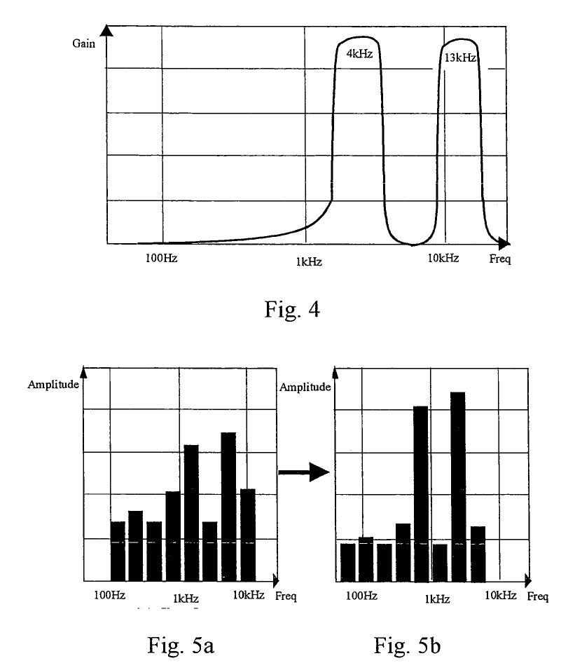

Instead of using a single passband as shown in FIG. 2b, the variable filter could switch between a single broad passband as shown in FIG. 2a and multiple passbands. One example is shown in FIG. 4 in which the modified spectrum has two passbands centred around 4 kHz and 13 kHz, the frequencies at which the human ear has maximum response.

FIG. 5 shows another example of modification of the frequency spectrum in which an intelligent filter amplifies only the dominant frequencies plus their harmonics within the ringtone whilst suppressing other frequencies. FIG. 5a is a schematic diagram of the original spectrum in which two frequencies dominate. In FIG. 5b these have been amplified whilst suppressing the remaining frequencies. This may be useful if it creates a sound that is more noticeable.

In order to implement the spectral ramping illustrated in FIGS. 3b and 3c simply and cheaply it would only be necessary to switch the filter in or out of the signal path. More sophisticated implementations of variable filtering and amplifications may for example be provided in the manner of a standard graphic equalizer as used in hi-fi systems. Software control is then able gradually to change the filtering to produce ramping such as that shown in FIG. 3a.

### INDUSTRIAL APPLICABILITY

As described above, the present invention provides a call annunciator for a portable wireless transceiver having a polyphonic ringtone generator, a speaker for reproducing the polyphonic ringtone and means for modifying the spectral content and amplitude of signals applied to the speaker, the modifying means being arranged to reduce the spectral content of the ringtone after a predetermined period whilst maintaining overall power.

1. A call annunciator for a portable wireless transceiver having a polyphonic ringtone generator and a speaker for reproducing the polyphonic ringtone and means for modifying the spectral content and amplitude of signals applied to the speaker, said modifying means being arranged to reduce the spectral content of the ringtone after a predetermined period whilst maintaining overall power.

2. A call annunciator as claimed in claim 1 including a band pass filter, the pass band of which is reduced after a predetermined period.

3. A call annunciator as claimed in claim 2 in which the reduced pass band excludes frequencies below 2 Hz.

4. A call annunciator as claimed in claim 2 in which the reduced pass band includes the range 3-8 kHz.

5. A call annunciator as claimed in claim 1 in which the spectral content is reduced by applying multiple band pass filtering to the polyphonic ringtone generator output.

6. A call annunciator as claimed in claim 5 in which the multiple pass band filtering uses pass bands including 4 kHz and 13 kHz respectively.

7. A call annunciator as claimed in claim 1 in which the reduction of spectral content is achieved by amplifying selected frequencies whilst suppressing others.

8. A call annunciator as claimed in claim 7 in which the selected frequencies include those having the highest amplitude.

9. A call annunciator as claimed in claim 8 in which the selected frequencies include harmonics of the frequencies having the highest amplitude.

10. A call annunciator as claimed in claim 1 including means for reducing the spectral content gradually over a predetermined period following the above-mentioned predetermined period.

11. A call annunciator as claimed in claim 1 which the spectral content is reduced in a single step after expiry of the predetermined period.

12. A call annunciator as claimed in claim 11 in which the spectral reduction step is reversed and repeated after subsequent intervals of time until the call is answered.
